(19) United States
(12) Patent Application Publication
(10) Pub. No.: US 2005/0279214 A1
(43) Pub. Date: Dec. 22, 2005

(54) Conical fermentor

(76) Inventor: John Richard Blichmann, Lafayette, IN (US)

Correspondence Address: JOHN R. BLICHMANN, 809. S. 10th ST, LAFAYETTE, IN, 47905, US

(21) Appl. No.: 10/873,791

(22) Filed: Jun. 22, 2004

(51) Int. Cl. C12C 1/00

(52) U.S. Cl. 99/276

(57) ABSTRACT

An improved homebrewing conical fermentor having pressure capability for CO2 pumping and carbonation, without welding onto the tank, which can lead to contamination of the fermenting product. In addition, the fermentor support legs remain permanently affixed to the tank without introducing any welding flaws on the inside of the tank. A removable access hatch is provided, again without any welding onto the tank lid. A lid seal is provided with a bead that improves sealing capability against the tank lip. Lastly, a removable lid design utilizing a band clamp that eliminates the need to weld the lid to the tank and allows for easy access to the interior of the fermentor for cleaning and sanitation.

### BACKGROUND

1. Field of the Invention

This invention relates generally to fermentors, specifically to conical fermentors for homemade beer and wine making.

2. Discussion of Prior Art

It is well known in the art to utilize a conical bottomed fermentor for fermenting beer or wine. The spent yeast and other fermentation materials settle to the bottom of the cone and can be easily removed by a drain valve located at the bottom of the cone. This eliminates the need to transfer (rack) the beer or wine to another container for secondary fermentation, and avoids the risk of contamination and oxidation.

Such conical fermentors for commercial breweries also have pressure capability for sanitarily pumping the finished product via CO2 pressure, and for forced carbonation of the finished product. Prior art homebrew fermentors utilize flat lids secured to the top of the fermentor with a clamping foot in the center of the lid. Others use a series of clamps or latches around the perimeter of the lid. Both of these prior art designs do not tolerate pressure due to the flexing of the lid due to uneven or inadequate clamping force and leak gas if pressurized, thereby preventing CO2 pumping or pressure carbonation.

Due to the large size of commercial fermentors, they are necessarily made from formed sheets of material (usually stainless steel or copper) welded together and carefully ground and polished on the interior to remove pits and other weld flaws which hide bacteria and contaminate the fermenting product. Legs are then welded to the exterior of the fermentor so that it may be set on a floor. Also provided is an access hatch for the adding of hops, finings, and the like, to the fermentor during the fermentation process and also to facilitate cleaning.

Prior art homebrewing conical fermentors are derivatives of the larger commercial fermentors, but are constructed from commercially available “hoppers”. These hoppers are formed from flat stainless sheet, deep-drawn into a pot, and then have a cone spun on the bottom. Unlike the larger commercial fermentors, they have a tremendous advantage of being formed without any welding whatsoever. This eliminates any risk of pitting and flaws associated with welding and the bacterial contamination that can ensue. In addition, the manufacturing costs are substantially lower using this method of manufacture.

However, affixing mounting legs, even though welded from the outside, leaves unavoidable permanent marking and burn-through pitting due to the comparatively thin walls of these commercially available one-piece drawn and spun tanks. Clamp-on leg designs exist, but are expensive to manufacture and clumsy to install and use. Other designs use a stand that does not remain affixed to the fermentor when moved, or for cleaning which is yet another large disadvantage for a small homebrew sized fermentor which are typically carried and cleaned in a household sink.

Lid seals for prior art fermentors are typically “U” shaped elastomeric seals that are placed over the edge of the tank lip or lid. Since the surfaces of these tank lips and lids are not perfectly flat, getting a gas and liquid tight seal is difficult and unreliable. Any air infiltration into the fermentor will stale (oxidize) the fermenting product negatively affecting the flavor.

Providing an access hatch in homebrew-sized fermentors is typically done by welding the top of a stainless soda keg onto the top of the fermenter as taught by the Sabco Company. However, this welding process can leave weld flaws and the associated problems of contamination. In addition, this is a costly method to provide this feature.

Finally, providing pressure capability without welding the lid onto the tank is unavoidable in prior art fermentors due to structural pressure limitations, making cleaning the small homebrewing fermentor very cumbersome since internal surfaces are difficult or impossible to reach.

### OBJECTS AND ADVANTAGES

Accordingly, it is an object of this invention to provide a conical fermentor with pressure capability without welding the lid onto the fermentor.

It is yet another object of the invention to provide an access hatch without welding onto the fermentor.

It is yet another object of this invention to provide a fermentor leg design that remains affixed to the fermentor for ease of cleaning and portability, but does not leave weld flaws on the interior of the fermentor.

It is a final object of the invention to provide a completely gas and liquid tight fermentor lid seal.

Further objects and advantages of my invention will become apparent from a consideration of the drawings and ensuing description.

### DESCRIPTION OF DRAWINGS

FIG. 1a and FIG. 1b show a side cut-away and top view respectively of the preferred embodiment of fermentor leg assembly.

FIG. 2a shows an alternate embodiment where a nut is used in lieu of a spacing collar. FIG. 2b shows an alternate embodiment where a collared stud is utilized in lieu of a spacing collar. FIG. 2c shows an alternate embodiment where an internally threaded standoff is utilized in lieu of a spacing collar. FIG. 2d shows an alternate embodiment where legs contain mounting flanges and leg is directly bolted to tank without spacers, collars or backing nuts.

FIG. 3a shows the preferred embodiment of beaded lid seal design. FIG. 3b shows an alternate embodiment of lid seal where bead is replaced with an edge-type design. FIG. 3c shows an alternate embodiment of lid seal where bead is replaced with a wiper-type design.

FIG. 4a shows the preferred embodiment of lid sealing mechanism. FIG. 4b shows an alternate embodiment where a clamp ring is used to reduce seal bunching when tightening. FIG. 4c shows an alternate embodiment where tank lip is a beaded design. FIG. 4d shows an alternate embodiment where a support ring is utilized to hold the seal properly in place and reduce seal bunching when tightening.

FIG. 5a shows a standard soda keg hatch assembly installed in a standard soda keg top. FIG. 5b shows standard soda keg hatch assembly with shortened legs installed on a flat lid thereby reducing manufacturing and tooling costs. FIG. 5c shows an alternate embodiment whereby stamped soda keg hatch lip profile is stamped directly into the lid, thereby eliminating the need to shorten the hatch legs.

### DESCRIPTION OF THE PREFERRED EMBODIMENTS

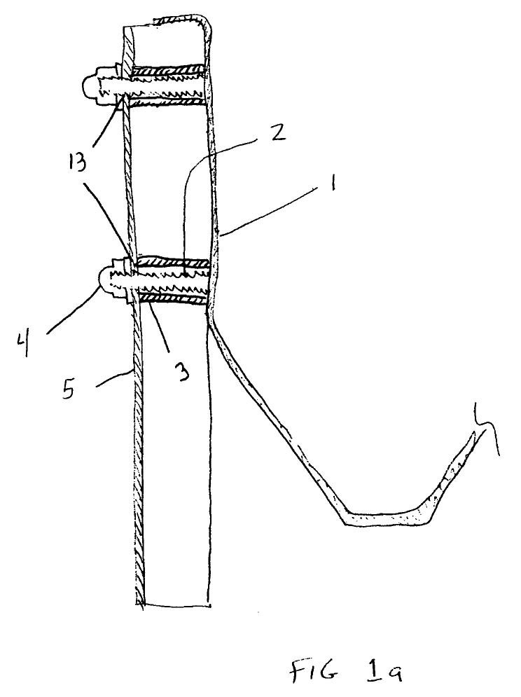

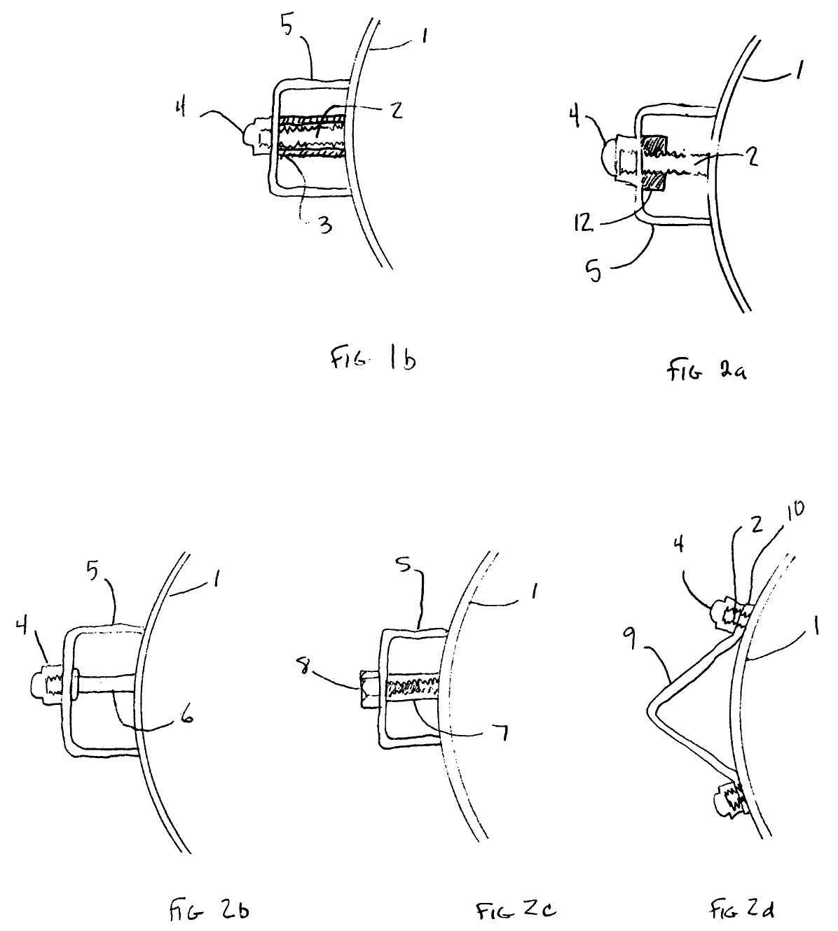

Referring to the drawings, and particularly FIG. 1a and FIG. 1b, a tank 1 is fitted with at least one capacitive discharge (CD) or arc studs 2. In the preferred embodiment, shown in FIG. 1a and FIG. 1b, a spacer 11 is placed over stud 2 to allow for full bolt torque. Leg 5, having appropriately placed mounting holes 13, is placed over studs 2 and fastened to tank 1 with nuts 4. At least three legs 5, are installed on tank 1, preferably 120 degrees apart for optimum stability.

In an alternate embodiment shown in FIG. 2a, a backing nut 12 is placed on stud 2 to the appropriate height. Leg 5 is then installed over studs 2 and secured with nut 4.

An alternate embodiment shown in FIG. 2b utilizes a collared stud 6, eliminating the need for spacer 3.

Another embodiment shown in FIG. 2c utilizes an internally threaded stand-off 7 in lieu of stud 2 and utilizes a cap screw 8 to affix leg 5 to tank 1. Internally threaded stand-off 7 eliminates the need for spacer 3 or collar on stud 6. Yet another embodiment shown in FIG. 2d utilizes a leg 9 with flanges 10 whereby studs 2 affix the leg to tank 1. Further embodiments not shown in the drawings include tubes, bars, “H” sections etc.

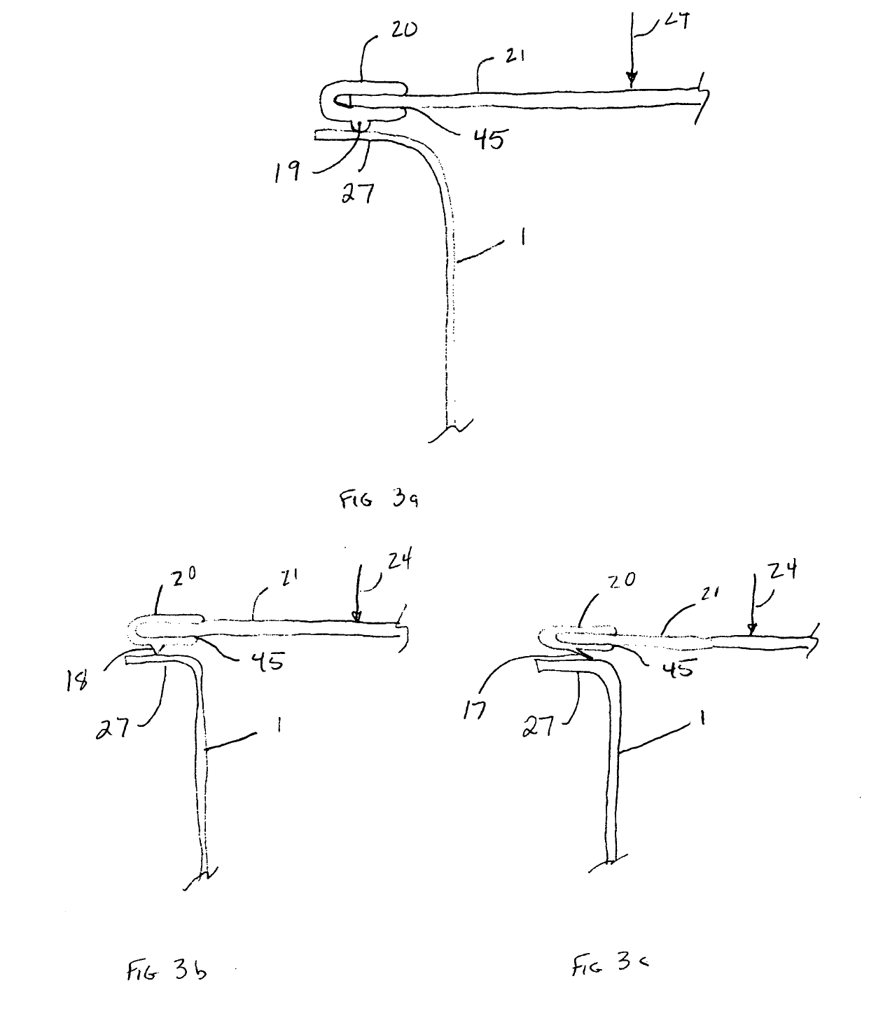

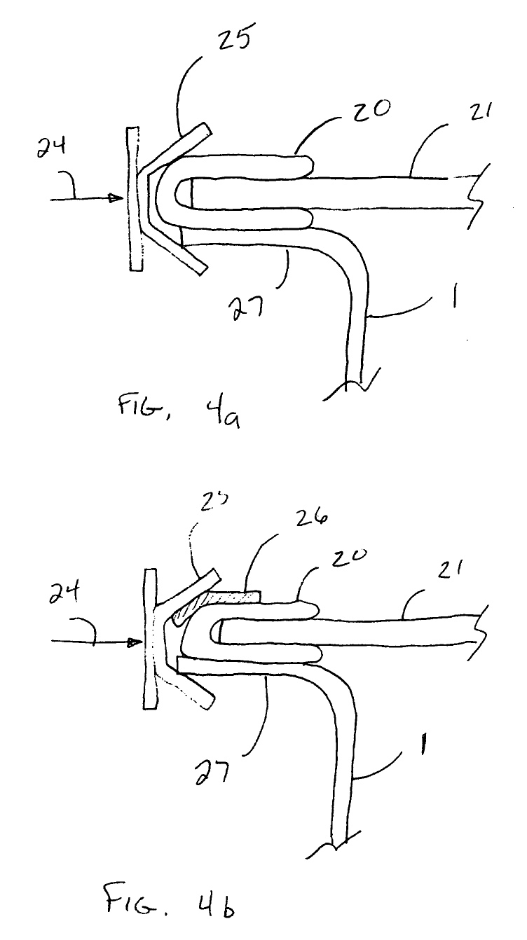

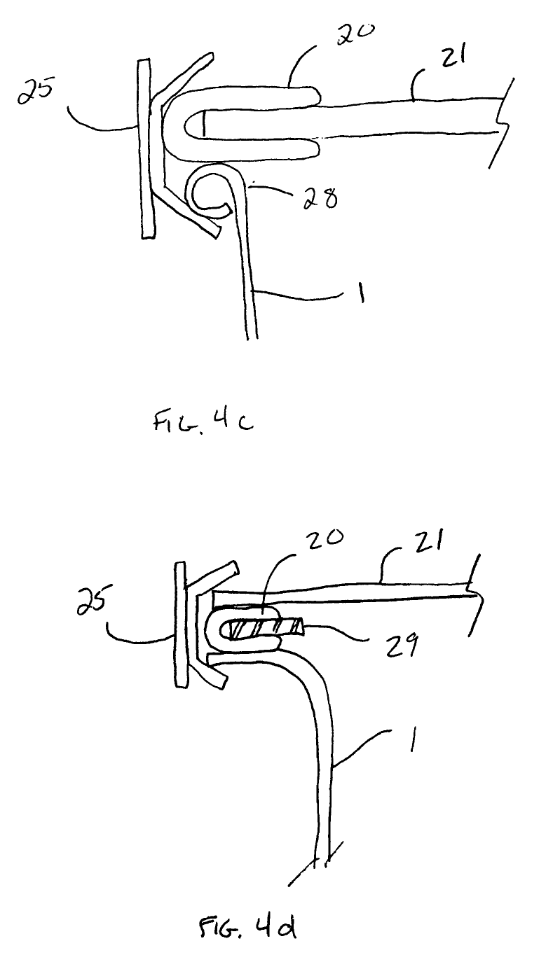

FIG. 3a shows a seal 20 with a bead 19 and a cavity 45 to receive lip of tank lid 21 or tank lip 27. Seal 20 preferably being constructed of a flexible elastomeric material. Seal 20 being utilized to provide a gas and liquid tight seal against tank lip 27 and lid 21. Bead 19 on seal 20 experiences a high localized pressure from a lid clamping force 24 and as a result deforms and creates a positive seal against tank lip 27. Alternately, bead 19 can be shaped into numerous profiles such as edge 18 as shown in FIG. 3b and wiper 17 as shown in FIG. 3c.

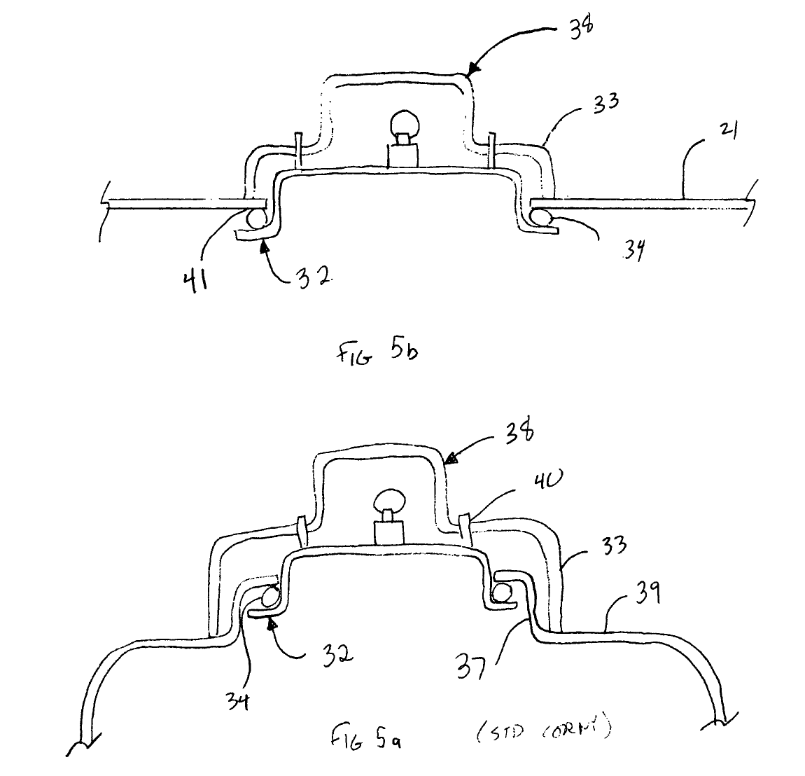

FIGS. 4a-d shows alternate methods to seal lid 21 against tank lip 27 using a band clamp 25 and seal 20 (shown without bead 19). In the preferred embodiment, shown in FIG. 4a, band clamp 25 provides clamping force 24 when tightened. FIG. 4b shows a clamp ring 26 preferably made from steel or hard plastic, which allows band clamp 25 to tighten with reduced bunching of seal 20. FIG. 4c shows a beaded lid lip 28 on tank 1. FIG. 4d shows yet another embodiment utilizing a seal support ring 29 that supports seal 20 during tightening of band clamp 25. Obviously, many combinations of similar band clamp assembly designs could be conceived, such as placing seal 20 on the lip of tank 1 instead of lid 21.

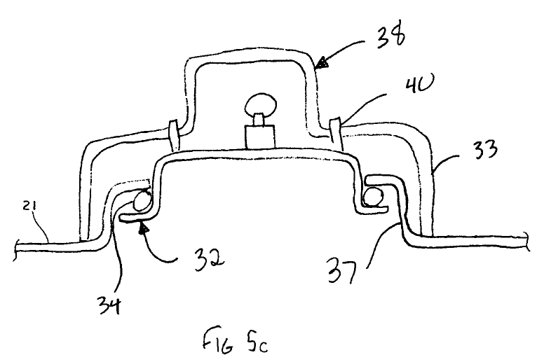

FIG. 5a shows a standard soda keg hatch assembly 32 installed in a standard soda keg top 39. A pair of hatch legs 33 on a handle assembly 38 is rotatably affixed about a hinge point 40. A hatch seal 34 is placed between lid assembly 32 and soda keg top 39. FIG. 5b shows the preferred embodiment of the invention where hatch legs 33 are shortened to allow lid 21 with a flat sealing surface 41 to be utilized in lieu of a stamped soda keg hatch lip 37 in soda keg top 39 having a form-fitting profile as shown in FIG. 5a. Alternately, lid 21 can be manufactured with a standard soda keg hatch lip 37 as an integral part of the lid as shown in FIG. 5c, thereby eliminating the need to shorten hatch legs 33.

### OPERATION OF THE PREFERRED EMBODIMENT

Referring to FIGS. 1a and 1b, stud 2 is welded to tank wall 1 utilizing a typical capacitive discharge or arc stud welding process. This welding process is ideally suited to welding studs and stand-offs to thin sheet steel leaving absolutely no marking on the opposite side of the sheet. Due to the extremely short arc duration of a CD or acc stud welding machine, the energy is concentrated in a very small area resulting in a strong weld and small heat affected zone. Since the interior side (opposite the stud) of the sheet is not heated substantially, there is absolutely no risk of burn through or pitting and the associated contamination issues. Yet the weld is permanent and very strong. In the preferred embodiment, spacer 3 is placed over stud 2. Leg 5 is then installed over stud 2 and nut 4 compresses leg 2 onto spacer 3, spacer 3 enabling full bolt torque. Although spacer 3 could be eliminated, full bolt torque cannot be applied resulting in an unsatisfactory, unsafe bolted joint design.

In an alternate embodiment, stud backing nut 12 is placed on stud 2 to the height dictated by leg 5 so legs rest against tank wall 1. Leg 5 is placed over stud 2 and fastened with nut 4, securing leg 5 to tank 1 with proper full bolt torque.

Alternately, stud 2 can be a collared stud 6 as shown in FIG. 2a where collar on stud 6 allows for full bolt torque. In yet another embodiment, a threaded standoff 7 is welded to tank 1 and cap screw 8 affixes leg 5 to the tank allowing for proper bolt torque. In another embodiment, shown in FIG. 2d, leg 9 is manufactured with flange 10. Flange 10 is held to tank 1 with stud 2 and nut 4. Obviously, many possible ramifications could be conceived utilizing tubes, H channels, bars, and the like in conjunction with the various variety of CD or arc weld fittings commercially available or custom manufactured to affix a leg to the fermentor.

A lid 21 is sealed against tank lip 27 with seal 20 containing bead 19 as shown in FIG. 3a. Cavity 45 of seal 20 is placed over lid 21. Alternately, cavity 45 can be placed over tank lip 27. As lid clamping force 24 is applied to lid 21 bead 19 experiences a high localized pressure and forms tightly against tank lip 27 creating a gas and liquid tight seal. Lid clamping force 24 can be from a multiple sources including, but not limited to, a pressure foot, draw latch, toggle clamp, or similar prior art means. Bead 19 can be many alternate shapes such as edge 18 shown in FIG. 3b, and wiper 17 shown in FIG. 3c.

As shown in FIG. 4a, clamp force 24 can be provided by a band clamp 25 placed over seal 20 and tank lip 27 encapsulating lid 21. Since typical band clamps provide high sealing forces, bead 19 is not required to function properly. FIG. 4b shows clamping ring 26, which prevents seal 20 from bunching during tightening. FIG. 4c shows an alternate beaded tank lip 28. FIG. 4d shows a seal support ring 29 used to support seal 20 when band clamp 25 is tightened. Obviously, band clamp 24 can be numerous shapes such as “V” shaped, “U” shaped, or many other common configurations.

FIG. 5a shows a standard soda keg hatch assembly 32 installed in a standard soda keg top 39. Since these lids are mass produced they are very cost effective and ideally suited for a homebrew sized fermentor access hatch. A pair of hatch legs 33 on a handle assembly 38 is rotatably affixed about a hinge point 40. A hatch seal 34 is placed between lid assembly 32 and soda keg top 39. When handle assembly 38 is rotated about hinge point 40, hatch legs 33 drive standard soda keg hatch assembly 32 upward thereby compressing hatch seal 34 creating a gas and liquid tight seal. FIG. 5b shows the preferred embodiment of the invention where legs 33 are shortened to compensate for the elimination of stamped soda keg hatch lip 37 in soda keg top 39 as shown in FIG. 5a. This allows for a simpler flat lid sealing surface 41 eliminating expensive stamping tooling or secondary manufacturing operations. Alternately, lid 21 can be manufactured with a standard soda keg hatch lip 37 profile stamped into it as an integral part of the lid as shown in FIG. 5c, thereby eliminating the need to shorten hatch legs 33. Depending on intended design pressure, it may be necessary to form the remaining surfaces of the lid into a dome shape to reduce lid flexing.

### SUMMARY, RAMIFICATIONS, AND SCOPE

Thus the reader will see that the improved conical fermentor provides the homebrewer with all the features of a commercial conical fermentor but does so without any chance of introducing welding flaws in the interior of the fermentor. While my description contains many specificities, these should not be construed as limitations of the scope of the invention, but rather as an exemplification of one preferred embodiment thereof. Many other variations of lid seal profiles, band clamp profiles, leg shapes, and leg clamping configurations are obviously possible. Accordingly, the scope of the invention should be determined not by the embodiments illustrated, but by the appended claims and their legal equivalents.

1. A conical fermentor leg assembly comprising:
a. at least one capacitive discharge or arc fitting welded to fermentor exterior
b. a leg installed on said capacitive discharge or arc fitting

2. Leg assembly of claim 1 wherein said leg assembly utilizes a spacer.

3. Leg assembly of claim 1 wherein said leg assembly utilizes a backing nut.

4. Leg assembly of claim 1 wherein said leg assembly utilizes a collared stud.

5. Leg assembly of claim 1 wherein said leg assembly utilizes an internally threaded stand-off.

6. Leg assembly of claim 1 wherein said leg assembly utilizes a mounting flange on said leg.

7. Leg assembly of claim 1 wherein said leg is a tube with a mounting hole through said tube.

8. A conical fermentor lid seal comprising:
a. a cavity to receive lip of a fermentor lid or a fermentor tank
b. at least one bead on said seal surface

9. Lid seal of claim 7 wherein said bead is an edge type profile.

10. Lid seal of claim 7 wherein said bead is a wiper type profile.

11. A conical fermentor lid clamp assembly comprising
a. a lid seal without bead placed on said lip of said fermentor lid
b. said fermentor lid placed on said fermentor tank lip
c. a band clamp installed over said fermentor lid and said fermentor tank lip

12. Lid clamp assembly of claim 11 wherein said lid clamp assembly utilizes a clamp ring installed on said seal.

13. Lid clamp assembly of claim 11 wherein said lid clamp assembly utilizes a support ring installed on said seal.

14. Lid clamp assembly of claim 11 wherein said tank lip is of a beaded shape.

15. Lid clamp assembly of claim 11 wherein said lid seal contains a bead.

16. A conical fermentor lid hatch assembly comprising:
a. a standard soda keg hatch assembly with a set of legs shortened to allow an over-center mechanism to properly compress a seal on said standard soda keg hatch assembly against a substantially flat sealing surface.
b. an oval hole in said fermentor lid for receiving said standard soda keg hatch assembly

17. Conical fermentor lid hatch assembly of claim 16 wherein said lid sealing surface contains a stamped profile eliminating the need to shorten said legs.
